(19) United States
(12) Patent Application Publication
(10) Pub. No.: US 2008/0311953 A1
(43) Pub. Date: Dec. 18, 2008

(54) Mobile communication device with combinative body function detecting modules

(76) Inventor: Ein-Yiao Shen, Taipei (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/762,667

(22) Filed: Jun. 13, 2007

(51) Int. Cl. H04M 1/00

(52) U.S. Cl. 455/556.2

(57) ABSTRACT

A mobile communication device with combinative body function-detecting modules mainly comprises a body function-detecting module to be combined with the mobile communication device, so that the body function-detecting module may monitor or detect the signals of the body function and the signals, as received, may be displayed, stored, announced or transmitted to remote sites through the mobile communication device for the user to monitor or detect the signals of the body function in real time with the mobile communication device. Further, the body function-detecting module is connected to the mobile communication device in external, built-in, built-out or short-distance wireless transmission ways. According to the present invention, the body function-detecting module may be combined with various mobile communication devices to provide added value to the utility of mobile communication devices, by which the user may monitor or detect himself at any time regarding to see whether his physiological signals are normal so that his health conditions may be known and monitored at any time.

### BACKGROUND OF THE INVENTION

1. Field of the Invention

The present invention relates to a mobile communication device with combinative body function-detecting modules and, particular, to a body function-detecting module to be communicatively combined with a mobile communication device.

2. Description of the Prior Art

As science and technology change with each passing day, the development of mobile communication device progresses with the evolving functions from single and simple, to complex ones such as Internet-enabled function, digital imaging function, sound recording function, and so on. Since mobile communication devices are so popularized that everyone has a device today, it is desirable to explore additional practical functions. In the present day, method to detect body temperature, blood pressure, pulse rate, blood sugar and blood oxygen level from the body surface are widely known; numerous portable physiological function-detecting/monitoring systems have been known for medical use. If an extension can be made so that a mobile communication device can display, announce, store or transmit body function data gathered by a sensor and processed by the mobile communication device, it will contribute greatly to fulfill an unmet need.

Owing to the rapid development of biochip techniques for detecting physiological function of the body, changes in many physiological conditions of the human body and their associated symptoms can be monitored by biochips, which can be attached to the body surface or implanted into the body. Further, diseases can be more readily detected in the body. Moreover, besides the biochip techniques, developed microelectronics and nanometer techniques enable small devices to measure and gather information, either from the body surface or from inside the body, regarding bodily functions. An example includes a microelectronic implant that is swallowed to examine the stomach and intestines.

From the above viewpoints, it is a primary goal for the future development of mobile communication devices to combine highly popularized mobile communication devices with body function-detecting modules for monitoring the physiological changes so as to help diagnose diseases and perform medical treatment.

### SUMMARY OF THE INVENTION

The primary objective of this invention is to provide a body function-detecting module to be combined with a mobile communication device, for monitoring or detecting signals of body function, wherein the signals can be displayed, stored, announced or transmitted to remote sites using the mobile communication device. As such, the user can monitor or detect himself at any time to see if his physiological signals are normal.

Another objective of this invention is to provide a mobile communication device with combinative body function-detecting modules, wherein the body function-detecting modules may include various measures or detectors/sensors for measuring physiological conditions, biochemical conditions, sebum, skin type, physical fitness, fat density, bone density, etc. The measurements of physiological conditions include measurements or detections of blood pressure, heart beat, electrocardiogram, blood sugar, blood oxygen, etc. And the measurements of biochemical conditions include analyses for blood, body fluid, breath, etc. The body function-detecting modules may be used in a contact mode, a non-contact mode, a scanning mode, or a placement mode.

A further objective of this invention is to provide a mobile communication device with combinative body function-detecting modules that may raise the added value in the utility of the mobile communication device.

Yet a further objective of this invention is to provide a mobile communication device with combinative body function-detecting modules that may perform real-time linking, monitoring, and detecting, and have the virtues of relative low cost, convenient operation, compact size for desired portability, extensive/extendable application, and so on.

A mobile communication device with combinative body function-detecting modules for fulfilling the above objectives mainly comprises a mobile communication device and body function-detecting modules, wherein the mobile communication device is combined with a combinative body function-detecting module and the body function-detecting module is communicatively combined with the mobile communication device. In one contemplated embodiment, the module and the communication device are combined via external wires. In another contemplated embodiment, the module and the communication device are combined such that the module is built-in as part of the communication device. In another contemplated embodiment, the module and the communication device are combined such that the module is built-out as an attachment accessory to the communication device. In yet another contemplated embodiment, the module and the communication device are combined via short-distance wireless transmission. Regardless of how the module and the communication device is combined, contemplated embodiments are electronically combined so that the body function-detecting module may monitor or detect body function signals of the user, and the signals can be displayed, stored, announced or transmitted to remote sites through the mobile communication device.

These features and advantages of the present invention will be fully understood and appreciated from the following detailed description of the accompanying drawings.

### BRIEF DESCRIPTION OF THE DRAWINGS

FIG. 1 is a diagram of the framework for implementation of the mobile communication device with combinative body function-detecting modules of the present invention;

FIG. 2 is a schematic diagram of a first embodiment of the mobile communication device with combinative body function-detecting modules;

FIG. 3 is a schematic diagram of a second embodiment of the mobile communication device with combinative body function-detecting modules;

FIG. 4 is a schematic diagram of a third embodiment of the mobile communication device with combinative body function-detecting modules; and

FIG. 5 is a schematic diagram of a forth embodiment of the mobile communication device with combinative body function-detecting modules.

### DESCRIPTION OF THE PREFERRED EMBODIMENT

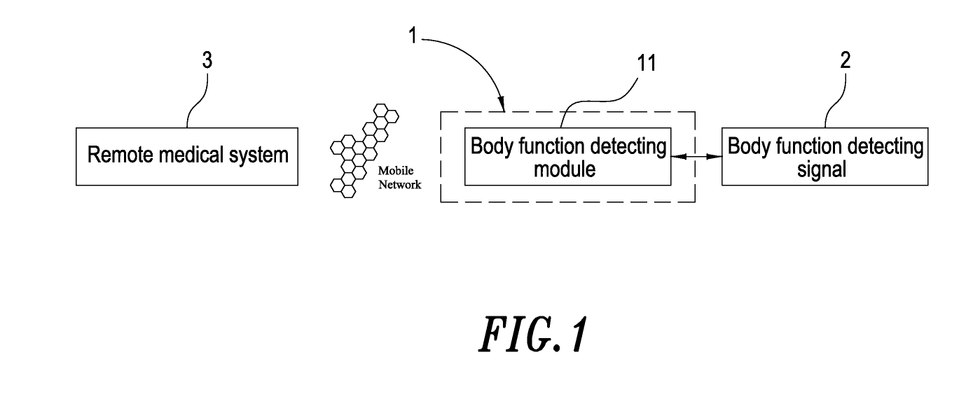

Refer to FIG. 1, which is a diagram of the framework for implementation of the mobile communication device with combinative body function-detecting modules of the present invention, the mobile communication device with combinative body function-detecting modules comprising: a mobile communication device 1, with a combinative body function-detecting module 11 for monitoring or detecting in real time the signals 2 of the body function, wherein the signals 2, as received, are displayed, stored, announced or transmitted to remote medical systems 3 through the mobile communication device 1. The mobile communication device 1 may be, for example, a mobile phone, a personal digital assistant, or a hand-held computer. The body function-detecting module 11 may be a measure or detector for measuring physiological conditions, biochemical conditions, sebum, skin type, physical fitness, fat density, or bone density. The measurements of physiological conditions may include those of blood pressure, heart beat, electrocardiogram, blood sugar, or blood oxygen. The measurements of biochemical conditions may include analysis for blood, body fluid, or breath. And, the body function-detecting module 11 may be used in a contact mode, a non-contact mode, a scanning mode, or a placement mode. Body function-detecting modules are used for detecting or retrieving physiological signals from human bodies. The body function detecting module is applied to get on to bodies in the following ways.
1. Contact mode: The body function detecting module is taken to contact the body so that the physiological signals can be obtained.
2. Non-contact mode: The body function detecting module is placed around without contacting the body while the physiological signals are obtained in the way of signal emission/reception.
3. Scan mode: Scanning signals (e.g., infra-red) are emitted from the body function detecting module so that the physiological signals can be obtained.
4. Embedded mode: Since the body function detecting module can be miniaturized, it can be implanted under the skin of the body or be swallowed and put inside the body so that the physiological signals can be obtained.

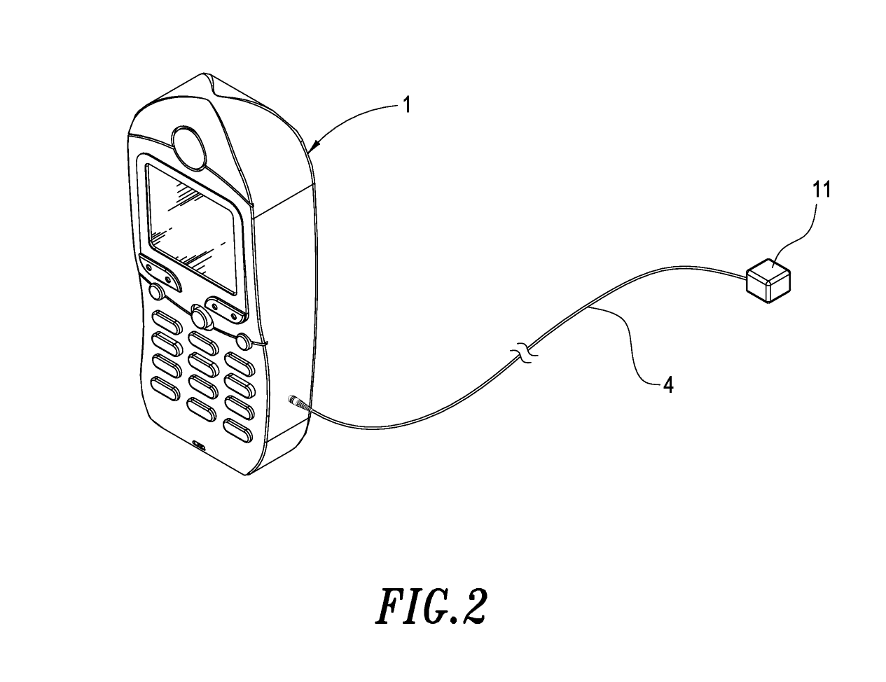

Refer to FIG. 2, which is a schematic diagram of a first embodiment of the mobile communication device with combinative body function-detecting module. The body function-detecting module 11 is connected to the mobile communication device 1 through a transmission line (electrical wire) externally, so that the mobile communication device 1 may monitor or detect bodily function signals 2 by the connected body function-detecting module 11, and the signals 2 as received, are displayed, stored, announced or transmitted to remote medical systems 3 through the mobile communication device 1.

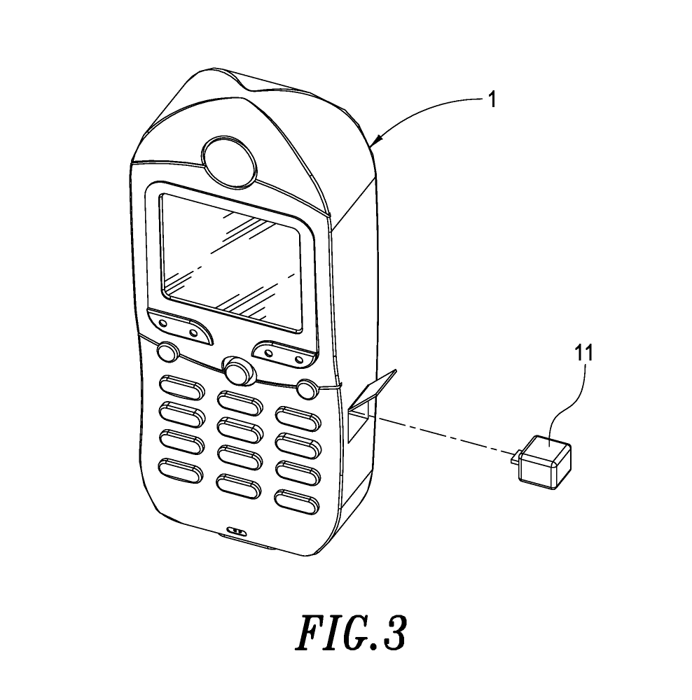

Refer to FIG. 3, which is a schematic diagram of a second embodiment of the mobile communication device with combinative body function-detecting modules. As shown in FIG. 3, the body function-detecting module 11 is connected to the mobile communication device 1 in a built-out way, so that the connected body function-detecting module 11 is detachably connected to the communication device 1. The “built-out” method is different from the attachment (in FIG. 2) in that the module 11 here does not remain external of the communication device 1 when the detachable connection is made. Here, the communication device 1 can monitor or detect bodily function signals 2, and the signals 2 as received, are displayed, stored, announced or transmitted to remote medical systems 3 through the mobile communication device 1.

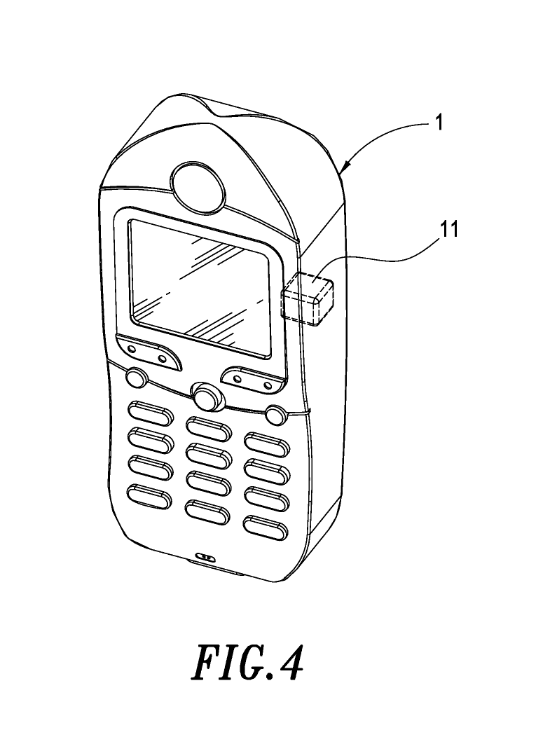

Refer to FIG. 4, which is a schematic diagram of a third embodiment of the mobile communication device with combinative body function-detecting modules. As shown in FIG. 4, the body function-detecting module 11 is “built-in” to the mobile communication device 1, so that the connected body function-detecting module 11 may monitor or detect the signals 2 of the body function, and the signals 2, as received, are displayed, stored, announced or transmitted to remote medical systems 3 through the mobile communication device 1.

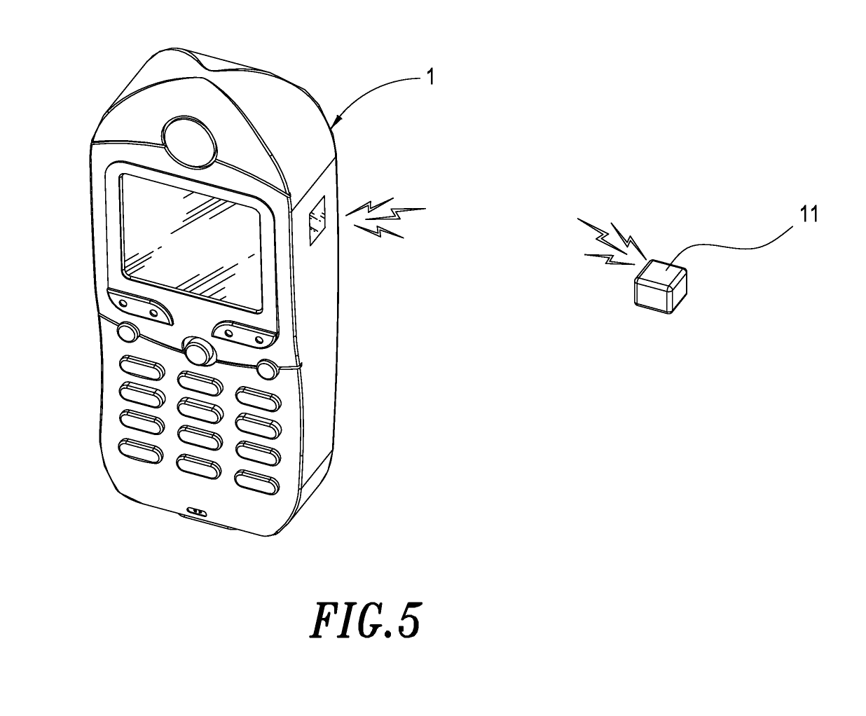

Refer to FIG. 5, which is a schematic diagram of a fourth embodiment of the mobile communication device with combinative body function-detecting modules. As shown in FIG. 5, the body function-detecting module 11 is connected to the mobile communication device 1 by short-distance wireless transmission, so that the connected body function-detecting module 11 can monitor or detect the signals 2 of the body function, and the signals 2, as received, are displayed, stored, announced or transmitted to remote medical systems 3 through the mobile communication device 1. The short-distance wireless transmission may be accomplished by infrared wireless transmission technique, Blue Tooth wireless transmission technique, IEEE 802.11 wireless transmission technique, Wibree wireless transmission technique, and the like. The mobile communication device with combinative body function-detecting modules provided by the present invention, as compared with conventional techniques, has the following additional advantages:

1. In one embodiment, the mobile communication device with combinative body function-detecting modules of the present invention has a body function-detecting module made as a modular part detachable to the mobile communication device; the signals of body function may be displayed, stored, announced or transmitted to remote sites through the mobile communication device, for the user to monitor or detect himself at any time regarding to see whether his physiological signals are normal, so that his health conditions may be known and monitored at any time, or constantly.

2. In another embodiment, the mobile communication device with combinative body function-detecting modules of the present invention has the body function-detecting module including various measures or detectors for measuring physiological conditions, biochemical conditions, sebum, skin type, physical fitness, fat density, or bone density, wherein the measurements of physiological conditions include measurements or detections of blood pressure, heart beat, electrocardiogram, blood sugar, or blood oxygen. The measurements of biochemical conditions include analysis for blood, body fluid, or breath. And, the body function-detecting modules may be used in a contact mode, a non-contact mode, a scanning mode, or a placement mode.

3. In another embodiment, the mobile communication device with combinative body function-detecting modules of the present invention provides added value to the use of mobile communication devices.

4. In another embodiment, the mobile communication device with combinative body function-detecting modules of the present invention performs real-time linking, monitoring, and detecting, and has the virtues of low cost, convenient operation, small size for portability, extensive application scope and so on.

5. In another embodiment, the mobile communication device with combinative body function-detecting modules of the present invention has the body function-detecting module manufactured separately by medical device manufacturers, and the body function-detecting module is then provided to mobile communication device manufacturers as a modular part to combine with the mobile communication device. This way, reduction of facilities and cost savings may be achieved for manufacturing the inventive subject matter.

Many changes and modifications in the above-described embodiment of the invention can, of course, be carried out without departing from the scope thereof. Accordingly, to promote the progress in science and the useful arts, the invention is disclosed and is limited only by the scope of the appended claims.

What is claimed is:

1. A mobile communication device with combinative body function-detecting modules, characterized in that the mobile communication device has outfits or signals for accommodating the body function-detecting module and the body function-detecting module is connected to the mobile communication device externally, so that the body function-detecting module can monitor or detect signals of the body function of the user, and the signals of the body function can be displayed, stored, announced or transmitted to remote sites through the mobile communication device.

2. The mobile communication device with combinative body function-detecting modules of claim 1, wherein the body function-detecting module is a measure or detector for measuring physiological conditions, biochemical conditions, sebum, skin type, physical fitness, fat density, or bone density, the measurements of physiological conditions include measurements of blood pressure, heart beat, electrocardiogram, blood sugar, or blood oxygen, and the measurements of biochemical conditions include analyses for blood, body fluid, or breath.

3. The mobile communication device with combinative body function-detecting modules of claim 1, wherein the body function-detecting module is used in a way selected from the group consisting of: contact mode, non-contact mode, scanning mode, and placement mode.

4. The mobile communication device with combinative body function-detecting modules of claim 1, wherein the mobile communication device is selected from the group consisting of: mobile phone, personal digital assistant, or hand-held computer.

5. The mobile communication device with combinative body function-detecting modules of claim 1, wherein the body function-detecting module is connected to the mobile communication device through a transmission line.

6. A mobile communication device with combinative body function-detecting modules, characterized in that the mobile communication device has outfits or signals for accommodating the body function-detecting module and the body function-detecting module is connectively built-in to the mobile communication device, so that the body function-detecting module can monitor or detect signals of the body function of the user, and the signals of the body function can be displayed, stored, announced or transmitted to remote sites through the mobile communication device.

7. The mobile communication device with combinative body function-detecting modules of claim 6, wherein the body function-detecting module is a measure or detector for measuring physiological conditions, biochemical conditions, sebum, skin type, physical fitness, fat density, or bone density, the measurements of physiological conditions include measurements of blood pressure, heart beat, electrocardiogram, blood sugar, or blood oxygen, and the measurements of biochemical conditions include analyses for blood, body fluid, or breath.

8. The mobile communication device with combinative body function-detecting modules of claim 6, wherein the body function-detecting module is used in a way selected from the group consisting of: contact mode, non-contact mode, scanning mode, and placement mode.

9. The mobile communication device with combinative body function-detecting modules of claim 6, wherein the mobile communication device is selected from the group consisting of: mobile phone, personal digital assistant, or hand-held computer.

10. A mobile communication device with combinative body function-detecting modules, characterized in that the mobile communication device has outfits or signals for accommodating the body function-detecting module and the body function-detecting module is connected to the mobile communication device in built-out way, so that the body function-detecting module can monitor or detect signals of the body function of the user, and the signals of the body function can be displayed, stored, announced or transmitted to remote sites through the mobile communication device.

11. The mobile communication device with combinative body function-detecting modules of claim 10, wherein the body function-detecting module is a measure or detector for measuring physiological conditions, biochemical conditions, sebum, skin type, physical fitness, fat density, or bone density, the measurements of physiological conditions include measurements of blood pressure, heart beat, electrocardiogram, blood sugar, or blood oxygen, and the measurements of biochemical conditions include analyses for blood, body fluid, or breath.

12. The mobile communication device with combinative body function-detecting modules of claim 10, wherein the body function-detecting module is used in a way selected from the group consisting of: contact mode, non-contact mode, scanning mode, and placement mode.

13. The mobile communication device with combinative body function-detecting modules of claim 10, wherein the mobile communication device is selected from the group consisting of: mobile phone, personal digital assistant, or hand-held computer.

14. A mobile communication device with combinative body function-detecting modules, characterized in that the mobile communication device has outfits or signals for accommodating the body function-detecting module and the body function-detecting module is connected to the mobile communication device via short-distance wireless transmission, so that the body function-detecting module can monitor or detect signals of the body function of the user, and the signals of the body function can be displayed, stored, announced or transmitted to remote sites through the mobile communication device.

15. The mobile communication device with combinative body function-detecting modules of claim 14, wherein the body function-detecting module is a measure or detector for measuring physiological conditions, biochemical conditions, sebum, skin type, physical fitness, fat density, or bone density, the measurements of physiological conditions include measurements of blood pressure, heart beat, electrocardiogram, blood sugar, or blood oxygen, and the measurements of biochemical conditions include analyses for blood, body fluid, or breath.

16. The mobile communication device with combinative body function-detecting modules of claim 14, wherein the body function-detecting module is used in a way selected from the group consisting of: contact mode, non-contact mode, scanning mode, and placement mode.

17. The mobile communication device with combinative body function-detecting modules of claim 14, wherein the mobile communication device is selected from the group consisting of: mobile phone, personal digital assistant, or hand-held computer.

18. The mobile communication device with combinative body function-detecting modules of claim 14, wherein the short-distance wireless transmission is selected from the group consisting of: infrared wireless transmission technique, Blue Tooth wireless transmission technique, IEEE 802.11 wireless transmission technique, and Wibree wireless transmission technique.
